(19) United States
(12) Patent Application Publication
(10) Pub. No.: US 2014/0210849 A1
(43) Pub. Date: Jul. 31, 2014

(54) DISPLAY DEVICE AND DISPLAY METHOD

(71) Applicant: E Ink Holdings Inc., Hsinchu (TW)

(72) Inventor: Jen-Yu CHANG, HSINCHU (TW)

(73) Assignee: E Ink Holdings Inc., Hsinchu (TW)

(21) Appl. No.: 14/064,212

(22) Filed: Oct. 28, 2013

(30) Foreign Application Priority Data
Jan. 28, 2013 (TW) 102103153

(51) Int. Cl. G06T 1/20; G09G 5/00; G09G 5/06

(52) U.S. Cl. CPC G06T 1/20; G09G 5/06; G09G 5/006
USPC 345/595

(57) ABSTRACT

The display device includes a display component, a storage component, and a processing component. The storage component is configured to store a plurality of index tables. Each index table includes a plurality of input-output-pairs. Each input-output-pair corresponds to a plurality of sub-pixel coordinate values, and a plurality of color component values. The processing component is configured to receive and correspond to a user command, to search a corresponding index table from the index tables, to search a corresponding input-output-pair from the input-output-pairs in the corresponding index table, and to provide some of the sub-pixel coordinate values and some of the color component values corresponding to the corresponding input-output-pair to the display component. The display component is configured to display an image according to the some of the sub-pixel coordinate values and the some of the color component values corresponding to the corresponding input-output-pair.

### RELATED APPLICATION

This application claims priority to Taiwanese Application Serial Number 102103153, filed Jan. 28, 2013, which is herein incorporated by reference.

### BACKGROUND

1. Field of Invention

The present disclosure is directed to an electronic device and an operating method. More particularly, the present invention is directed to a display device and a display method.

2. Description of Related Art

With advances in technology, various display devices have been widely used in human life, such as tablet computers and e-paper devices.

Generally, the display device can include a processing component and a display component. The processing component can be used to receive a user command (e.g., drawing a rectangle) and to perform a function so as to generate and output display data to the display component. The display component is used to receive and according to the display data to display an image (e.g. a rectangle) corresponding to the user command. However, in such a way, the display speed and response time of the display device is limited by the operating speed of the processing component, and thereby being hard to be efficiently improved.

Therefore, a display device with faster display speed and shorter response time is desired.

### SUMMARY

One aspect of the present invention is a display device. In accordance with one embodiment of the present invention, the display device includes a display component, a storage component, and a processing component. The display component includes a plurality of pixels Each of the pixels has a pixel coordinate value. Each of the pixels comprises a plurality of sub-pixels. Each of the sub-pixels of the pixels has a sub-pixel coordinate value. The storage component is configured to store a plurality of index tables. Each of the index tables includes a plurality of input-output-pairs. Each of the input-output-pairs corresponds to a plurality of sub-pixel coordinate values and a plurality of color component values. The processing component is configured to receive and correspond to a user command, to search a corresponding index table from the index tables, to search a corresponding input-output-pair from the input-output-pairs in the corresponding index table, and to provide some of the sub-pixel coordinate values and some of the color component values corresponding to the corresponding input-output-pair to the display component. The display component is configured to display an image according to the some of the sub-pixel coordinate values and the some of the color component values corresponding to the corresponding input-output-pair.

In accordance with one embodiment of the present invention, some of the sub-pixels having the some of the sub-pixel coordinate values corresponding to the corresponding input-output-pair display a plurality of sub-pixel colors according to the some of the color component values corresponding to the corresponding input-output-pair.

In accordance with one embodiment of the present invention, the user command comprises a selected function, at least one input pixel coordinate value, and a selected color value.

In accordance with one embodiment of the present invention, the processing component is further configured to search the corresponding index table from the index tables according to the elected function of the user command.

In accordance with one embodiment of the present invention, each of the input-output-pairs in the index tables further corresponds to at least one of the pixel coordinate values and an index color value. The processing component is further configured to compare the at least one input pixel coordinate value in the user command with the pixel coordinate values corresponding to the input-output-pairs in the corresponding index table, and compare the selected color value of the user command with the index color values corresponding to the input-output-pairs in the corresponding index table, so as to search the corresponding input-output-pair.

In accordance with one embodiment of the present invention, the at least one input pixel coordinate value of the user command includes a first input pixel coordinate value and a second input pixel coordinate value. The at least one pixel coordinate value of each of the input-output-pairs in the corresponding index table includes a first pixel coordinate value and a second pixel coordinate value. The processing component is further configured to compare the first input pixel coordinate value in the user command with the first pixel coordinate values corresponding to the input-output-pairs, compare the second input pixel coordinate value in the user command with the second pixel coordinate values corresponding to the input-output-pairs, and compare the selected color value of the user command with the index color values corresponding to the input-output-pairs in the corresponding index table, so as to search the corresponding input-output-pair.

Another aspect of the present invention is a display method. In accordance with one embodiment of the present invention, the display method is used in a display device. The display device includes a display component, a storage component, and a processing component. The display component includes a plurality of pixels. Each of the pixels has a pixel coordinate value. Each of the pixels comprises a plurality of sub-pixels. Each of the sub-pixels of the pixels has a sub-pixel coordinate value. The storage component is configured to store a plurality of index tables. Each of the index tables includes a plurality of input-output-pairs. Each of the input-output-pairs corresponds to a plurality of sub-pixel coordinate values, and a plurality of color component values. The display method includes a step of receiving and according to a user command to search a corresponding index table from the index tables, a step of searching a corresponding input-output-pair from the input-output-pairs in the corresponding index table according to the user command, a step of providing some of the sub-pixel coordinate values and some of the color component values corresponding to the corresponding input-output-pair to the display component, and a step of displaying an image according to the some of the sub-pixel coordinate values and the some of the color component values corresponding to the corresponding input-output-pair.

In accordance with one embodiment of the present invention, the step of receiving and according to the user command to search the corresponding index table from the index tables includes a step of making some of the sub-pixels having the some of the sub-pixel coordinate values corresponding to the corresponding input-output-pair display a plurality of sub-pixel colors according to the some of the color component values corresponding to the corresponding input-output-pair.

In accordance with one embodiment of the present invention, the user command includes a selected function, at least one input pixel coordinate value, and a selected color value. The step of searching the corresponding input-output-pair from the input-output-pairs in the corresponding index table includes a step of searching the corresponding index table from the index tables according to the selected function of the user command.

In accordance with one embodiment of the present invention, each of the input-output-pairs in the index tables further corresponds to at least one of the pixel coordinate values and an index color value. The step of searching a corresponding input-output-pair from the input-output-pairs in the corresponding index table according to the user command includes a step of comparing the at least one input pixel coordinate value in the user command with the pixel coordinate values corresponding to the input-output-pairs in the corresponding index table, and a step of comparing the at least one input pixel coordinate value in the user command with the pixel coordinate values corresponding to the input-output-pairs in the corresponding index table.

In accordance with one embodiment of the present invention, the at least one input pixel coordinate value of the user command includes a first input pixel coordinate value and a second input pixel coordinate value. The at least one pixel coordinate value of each of the input-output-pairs in the corresponding index table includes a first pixel coordinate value and a second pixel coordinate value. The step of searching the corresponding input-output-pair from the input-output-pairs in the corresponding index table according to the user command includes a step of comparing the first input pixel coordinate value in the user command with the first pixel coordinate values corresponding to the input-output-pairs, a step of comparing the second input pixel coordinate value in the user command with the second pixel coordinate values corresponding to the input-output-pairs, and step of comparing the selected color value of the user command with the index color values corresponding to the input-output-pairs in the corresponding index table.

In summary, by applying one embodiment above mentioned, the processing component can utilize the index tables to search out the required display data without performing functions, such that the display speed of the display device can be improved.

On the other hand, by applying another embodiment above mentioned, the display device can merely update the sub-pixel colors of the sub-pixels having the sub-pixel coordinate values corresponding to the corresponding input-output-pair, such that the display speed of the display device can also be improved.

### BRIEF DESCRIPTION OF THE DRAWINGS

The invention can be more fully understood by reading the following detailed description of the embodiment, with reference made to the accompanying drawings as follows:

FIG. 1 is a schematic diagram illustrating a display device in accordance with one embodiment of the present invention;

FIG. 2 is a schematic diagram illustrating an index table in accordance with one embodiment of the present invention;

FIG. 3 is a schematic diagram illustrating another index table in accordance with one embodiment of the present invention; and

FIG. 4 is a flow chart illustrating the display method in accordance with one embodiment of the present invention.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details In other instances, well-known structures and devices are schematically shown in order to simplify the drawing.

For the term “first”, “second” or the like used herein do not specifically indicate the order or sequence, as well as not being used for limiting the present invention, and is only used for distinguishing elements or operations described with the same technical terms.

For the term “electrically connect” or “connect” used herein, both of them can refer to the physical contact or electrical contact performed directly or indirectly between two or more elements. The term “electrically connect” or “connect” can further refer to the interoperation or interaction between two or more elements.

One aspect of the present invention is a display device. The display device can be a tablet computer, an e-paper device, and so on. For purpose of clarification, the e-paper device is taken as an example in the following paragraphs.

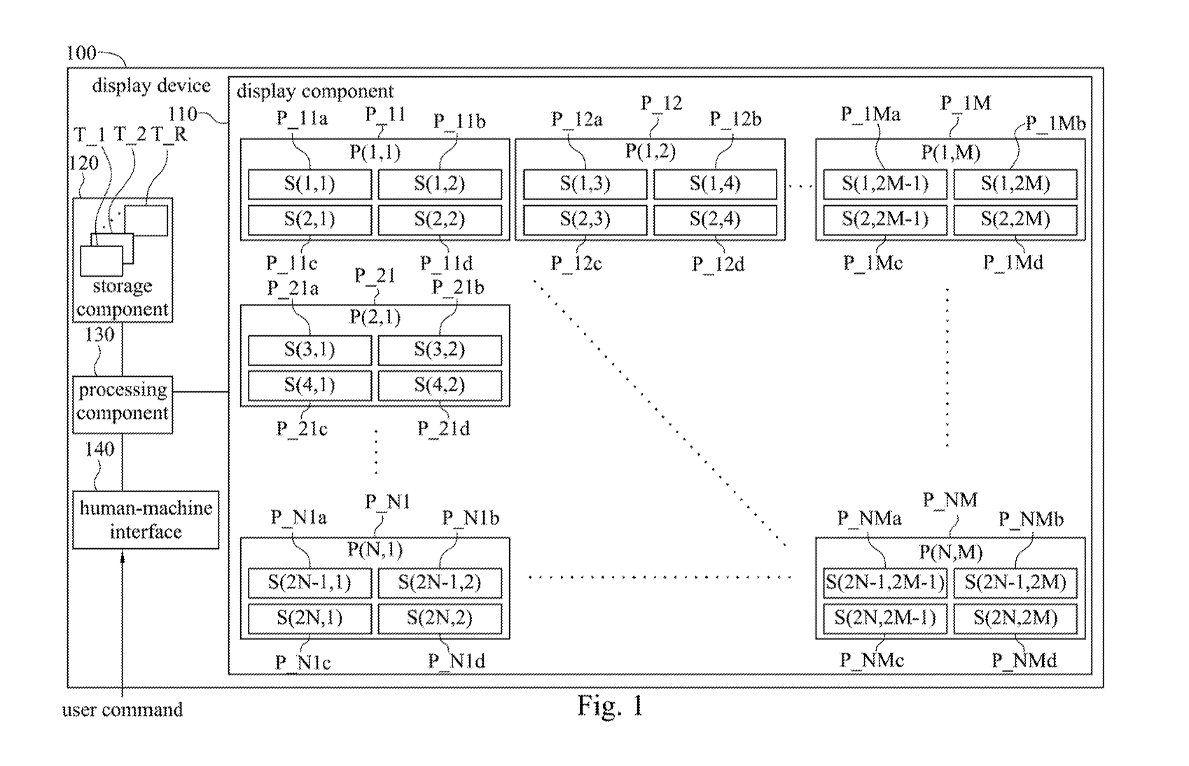

FIG. 1 is a schematic diagram illustrating a display device 100 in accordance with one embodiment of the present invention. The display device 100 includes a display component 110, a storage component 120, a processing component 130, and a human-machine interface 140. The processing component 130 can be separately connected to the display component 110, the storage component 120, and the human-machine interface 140.

In this embodiment, the display component 110 is, for example a display panel, an e-paper component or other components configured to display images. The storage component 120 is, for example, a memory or other components configured to store data. The processing component 130 is, for example, a central processor, a micro processor, or other components configured to process data. The human-machine interface 140 is, for example, a keyboard, a mouse, a touch panel, or other components a user can input data to the display device through which.

In this embodiment, the display component 110 can include a plurality of pixels, such as the pixels P_11-P_NM, in which N, M are integers. The pixels P_11-P_NM can respectively have different pixel coordinate values, such as P(1, 1)-P(N, M). For example, the pixel P_11 can have the pixel coordinate value P(1, 1), and the pixel P_12 can have the pixel coordinate value P(1, 2).

In this embodiment, each of the pixels P_11-P_NM can include a plurality of sub-pixels, for example, the pixel P_11 can include sub-pixels P_11a-P_11d, and the pixel P_12 can include sub-pixels P_12a-P_12d. The sub-pixels P_11a-P_NMd can respectively have different sub-pixel coordinate values, such as S(1, 1)-S(2N, 2M). For example, the sub-pixel P_11a can have the sub-pixel coordinate value S(1, 1), and the sub-pixel P_12a can have the sub-pixel coordinate value S(1, 3). In this embodiment, the sub-pixels P_11a-P_NMd can be used to display different colors of the pixels P_11-P_NM. For example, the sub-pixel P_11a can display a red color of the pixel P_11, the sub-pixel. P_11b can display a green color of the pixel P_11, the sub-pixel. P_11c can display a blue color of the pixel P_11, and the sub-pixel P_11d can display a white color of the pixel P_11.

It should be noted that, in the embodiments of this application, although the sub-pixels P_11a-P_NMd are disposed with RGBW-type, but the sub-pixels P_11a-P_NMd can also be disposed with other types such as RGB-stripe-type, and the disposition of the sub-pixels P_11a-P_NMd are not limited by the disposition of the embodiment in FIG. 1.

In this embodiment, the storage component 120 can be configured to store a plurality of index tables, such as the index tables T_1-T_R, in which R is an integer. Each of the index tables T_1-T_R can include a plurality of input-output-pairs. Each of the input-output-pair has an input portion and an output portion. The input portion can correspond to at least one of the pixel coordinate values P(1, 1)-P(N, M) and an index color value. The output portion can correspond to some of the sub-pixel coordinate values S(1, 1)-S(2N, 2M) and a plurality of color component values.

The index tables T_1-T_R can correspond to different functions (e.g., drawing a point, drawing a frame, drawing a rectangle, reversing characters, highlight characters, and so on). Each of the index tables T_1-T_R can store output data (i.e., display data) of one of the functions corresponding to different input data.

Through looking up the index tables T_1-T_R, the processing component 130 can rapidly search the display data from the index tables T_1-T_R without exactly performing the functions, such that the display speed of the display device can be increased.

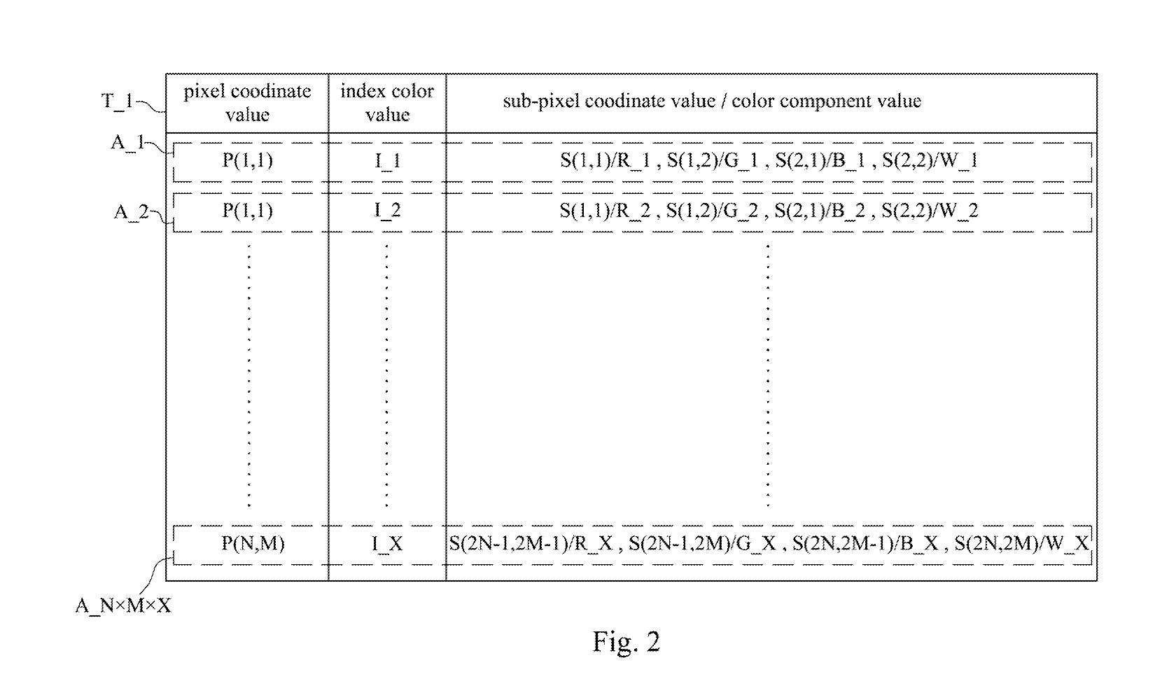

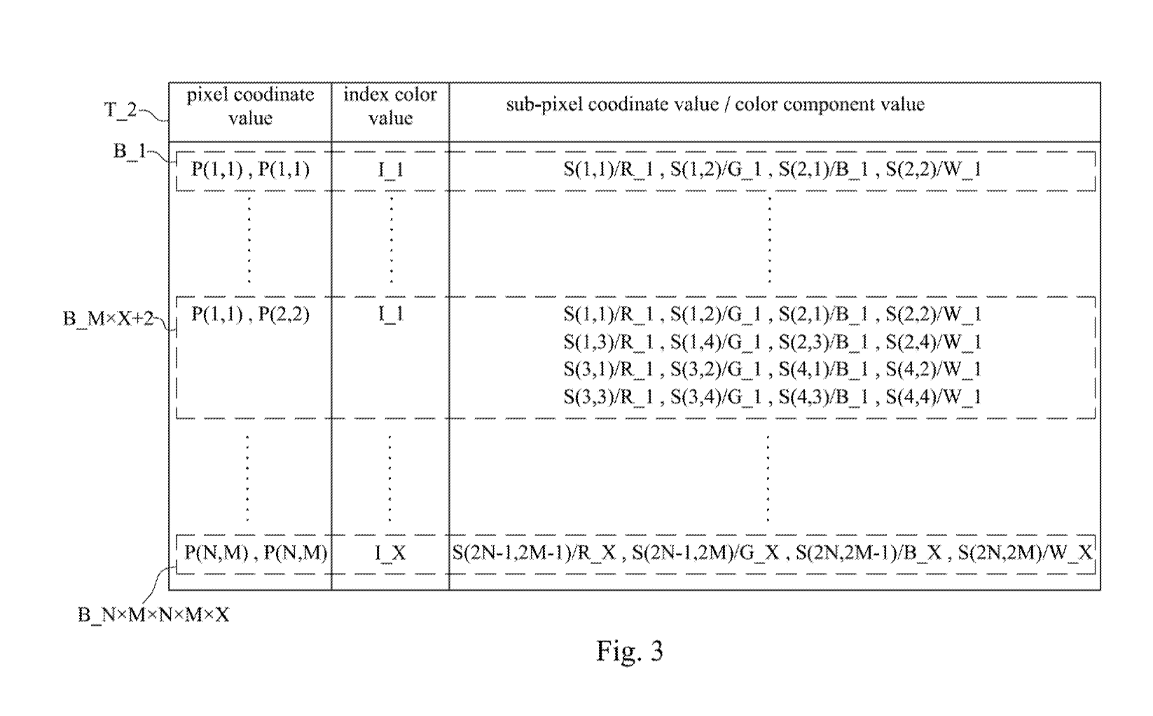

In the following paragraphs, the index tables T_1, T_2 in FIG. 2 and FIG. 3 will be taken as examples to provide more details of different index tables in one embodiment of the present invention.

Referring to FIG. 2, in this embodiment, the index table T_1, for example, can correspond to the function for drawing a point. The index table T_1 can include a plurality of input-output-pairs A_1-A_N×M×X, in which X is an integer. The input portion of each of the input-output-pairs A_1-A_N×M×X can correspond to one of the pixel coordinate values P(1, 1)-P(N, M) and one of the index color values I_1-I_X. The output portion of each of the input-output-pairs A_1-A_N×M×X can correspond to some of the sub-pixel coordinate values S(1, 1)-S(2N, 2M) and some of the color component values R_1-R_X, G_1-G_X, B_1-B_X, W_-W_X. The sub-pixel coordinate values S(1, 1)-S(2N, 2M) can separately correspond to the color component values R_1-R_X, G_1-G_X, B_1-B_X, W_1-W_X. For example, the input portion of the input-output-pair A_1 can correspond to the pixel coordinate value P(1, 1) and the index color values I_1, the output portion of the input-output-pair A_1 can correspond to the sub-pixel coordinate values S(1, 1)-S(2, 2) and the color component values R_1, G_1, B_1, W_1 the input portion of the input-output-pair A_2 can correspond to the pixel coordinate value P(1, 1) and the index color values I_2, the output portion of the input-output-pair A_2 can correspond to the sub-pixel coordinate values S(1, 1)-S(2, 2) and the color component values R_2, G_2, B_2, W_2, the input portion of the input-output-pair A_N×M×X can correspond to the pixel coordinate value P(N, M) and the index color values I_X, and the output portion of the input-output-pair A_N×M×X can correspond to the sub-pixel coordinate values S(2N-1, 2M-1)-S(2N, 2M) and the color component values R_X, G_X, B_X, W_X.

In other words, the index table T_1, for example, records the sub-pixel coordinate values of the sub-pixels P_11a-P_NMd and the color component values corresponding to each of the pixels P_11-P_NM in the display component 110 displays a pixel color corresponding to each of the index colors I_1-I_X. For example, when the pixel P_11 display a pixel color corresponding to the index color value I_1 the sub-pixel P_11a corresponds to the color component value R_1, the sub-pixel P_11b corresponds to the color component value G_1 the sub-pixel P_11c corresponds to the color component value B_1, and the sub-pixel P_11d corresponds to the color component value W_1.

Referring to FIG. 3, in this embodiment, the index table T_2, for example, can correspond to the function for drawing a rectangle. The index table T_2 can include a plurality of input-output-pairs B_1-B_N×M×N×M×X. Each of the input-output-pairs B_1-B_N×M×N×M×X can correspond to two of the pixel coordinate values P(1, 1)-P(N, M)(e.g., a first pixel coordinate value and a second pixel coordinate value), one of the index color values I_1-I_X, some of the sub-pixel coordinate values S(1, 1)-S(2N, 2M), and some of the color component values R_1 R_X, G_1-G_X, B_1-B_X, W_1-W_X. For example, the input-output-pair B_1 can correspond to the first pixel coordinate value P(1, 1), the second pixel coordinate value P(1, 1), the index color value I_1, the sub-pixel coordinate values S(1, 1)-S(2, 2), and the color component values R_1, G_1, B_1, W_1. The input-output-pair B_M×X+2 can correspond to the first pixel coordinate value P(1, 1), the second pixel coordinate value P(2, 2), the index color value I_1, the sub-pixel coordinate values S(1, 1)-S(4, 4), and the color component values R_1, G_1, B_1, W_1. The input-output-pair B_N×M×N×M×X can correspond to the first pixel coordinate value P(N, M), the second pixel coordinate value P(N, M), the index color value I_X, the sub-pixel coordinate values S(2N-1, 2M-1)-S(2N, 2M), and the color component values R_X, G_X, B_X, W_X.

In other words, the index table T_2, for example, records the sub-pixel coordinate values of the sub-pixels P_11a-P_NMd and the color component values corresponding to one or some of the pixels P_11-P_NM corresponding to each of rectangles (e.g., in each of rectangles) display(s) a pixel color corresponding to each of the index colors I_1-I_X, in which two endpoints of a diagonal of the rectangles correspond to any one or two of the pixels P_11-P_NM in the display component 110. For example, when the pixels P_11, P12, P21, P_22 corresponding to a rectangle display a pixel color corresponding to the index color value I_1, in which two endpoints of the diagonal of the rectangle correspond to pixels P_11, P_22, the sub-pixel P_11a corresponds to the color component value R_1, the sub-pixel P_11b corresponds to the color component value G_1, the sub-pixel P_11c corresponds to the color component value B_1, and the sub-pixel P_11d corresponds to the color component value W_1.

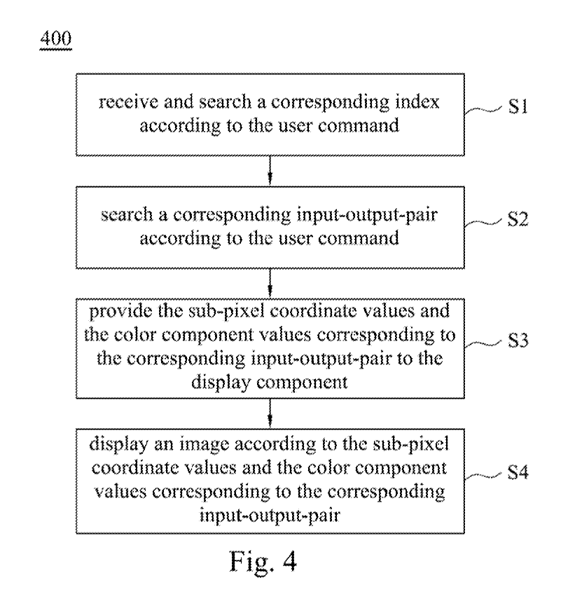

In the following paragraphs, the display method 400 in FIG. 4 will be taken as an example for describing the operation of the display device.

FIG. 4 is a flow chart illustrating the display method 400 in accordance with one embodiment of the present invention. The display method 400 can, but not limited to, be applied to the display device 100.

Referring to FIG. 1-FIG. 4, the processing component 130 can receive a user command through the human-machine interface 140 and search a corresponding index from the index tables T_1-T_R according to the user command (step S1). Then, the processing component 130 can search a corresponding input-output-pair from the input-output-pairs in the corresponding index table according to the user command (step S2). Then, the processing component 130 can provide some of the sub-pixel coordinate values and some of the color component values corresponding to the corresponding input-output-pair to the display component 110 (step S3). The display component 110 can display an image according to the some of the sub-pixel coordinate values and the some of the color component values corresponding to the corresponding input-output-pair (step S4).

For example, if the user command corresponds to the function for drawing a point, then the corresponding index table, for example, is the index table T_1 illustrated in FIG. 2. If the user command is for making the pixel P_11 which having the pixel coordinate value P(1, 1) displaying a pixel color according to the index color I_2, then the corresponding input-output-pair, for example, is the input-output-pair A_2. The some of the sub-pixel coordinate values corresponding to the input-output-pair A_2, for example, are the sub-pixel coordinate values S(1, 1)-S(2, 2). The some of the color component values corresponding to the input-output-pair A_2, for example, are color component values R_2, G_2, B_2, W_2. The display component 110 can receive and according to the sub-pixel coordinate values S(1, 1)-S(2, 2) and the color component values R_2, G_2, B_2, W_2 corresponding to the sub-pixel coordinate values S(1, 1)-S(2, 2) to display the image (e.g., drawing the point).

For another example, if the user command corresponds to the function for drawing a rectangle, then the corresponding index table, for example, is the index table T_2 illustrated in FIG. 3. If the user command is for making the pixels in the rectangle displaying a pixel color according to the index color I_1, in which the endpoints of a diagonal of the rectangle are the pixels P_11, P_22 having the pixel coordinate values P(1, 1), P(2, 2) separately, then the corresponding input-output-pair, for example, is the input-output-pair B_M×X+2. The some of the sub-pixel coordinate values corresponding to the input-output-pair B_M×X+2, for example, are the sub-pixel coordinate values S(1, 1)-S(4, 4). The some of the color component values corresponding to the input-output-pair B_M×X+2, for example, are color component values R_1, G_1, B_1, W_1. The display component 110 can receive and according to the sub-pixel coordinate values S(1, 1)-S(4, 4) and the color component values R_1, G_1, B_1, W_1 corresponding to the sub-pixel coordinate values S(1, 1)-S(4, 4) to display the image (e.g., drawing the rectangle).

In the prior art, the display device performs a function according to a user command after receiving the user command, and then generates and output display data to the display component.

However, in one embodiment above mentioned, through previously storing the display data (Le., the output data)of the functions in the index tables, the display device 100 can looking up the index tables T_1-T_R to rapidly search the display data from the index tables T_1-T_R without exactly performing the functions. In such a way, the display speed of the display device 100 can be efficiently increased.

Moreover, in one embodiment, because that the e-paper device is capable of updating a portion of a image, through the way above mentioned, the display device 100 can merely update the sub-pixel colors of the sub-pixels in the display component 110 having the sub-pixel coordinate values corresponding to the corresponding input-output-pair, such that the display speed of the display device can also be improved.

In accordance with one embodiment of the present invention, the user command can include a selected function, at least one input pixel coordinate value, and a selected color value. In the step S1, the processing component 130 can further be configured to searching the corresponding index table from the index tables T_1-T_R stored in the storage component 120 according to the selected function (e.g., drawing a point, drawing a frame, drawing a rectangle, reversing characters, highlight characters, and so on) of the user command. For example,if the selected function of the user command is for drawing a point, the processing component 130 can search the corresponding index table (e.g., index table T_1) corresponding to a function for drawing a point.

In accordance with one embodiment of the present invention, in the step S2, the processing component 130 can further be configured to compare the at least one input pixel coordinate value in the user command with the pixel coordinate values corresponding to the input-output-pairs in the corresponding index table, and to compare the selected color value of the user command with the index color values corresponding to the input-output-pairs in the corresponding index table, so as to search the corresponding input-output-pair. For example, in a case that the corresponding index table is the index table T_1, the processing unit 130 can separately compare the input pixel coordinate value with the pixel coordinate values P(1, 1)-P(N, M) corresponding to the input-output-pairs A_1-A_N×M×X, and separately compare the selected color value with the index color values I_1-I_X corresponding to the input-output-pairs A_1-A_N×M×X. When the input pixel coordinate value corresponds to pixel coordinate value P(1, 1), and the selected color value is I_2, the corresponding input-output-pair is the input-output-pair A_2.

In accordance with one embodiment of the present invention, the at least one input pixel coordinate value of the user command includes a first input pixel coordinate value and a second input pixel coordinate value. In the step S2, the processing component 130 can further be configured to compare the first input pixel coordinate value in the user command with the first pixel coordinate values corresponding to the input-output-pairs in the corresponding index table,to compare the second input pixel coordinate value in the user command with the second pixel coordinate values corresponding to the input-output-pairs in the corresponding index table, and to compare the selected color value of the user command with the index color values corresponding to the input-output-pairs in the corresponding index table, so as to search the corresponding input-output-pair. For example, in a case that the corresponding index table is the index table T_2, the processing unit 130 can separately compare the first input pixel coordinate value and the first pixel coordinate values P(1, 1)-P(N, M) corresponding to the input-output-pairs B_1-B_N×M×N×M×X, separately compare the second input pixel coordinate value and the second pixel coordinate values P(1, 1)-P(N, M) corresponding to the input-output-pairs B_1-B_N×M×N×M×X, and separately compare the selected color value with the index color values I_1-I_X corresponding to the input-output-pairs B_1-B_N×M×N×M×X. When the first input pixel coordinate value corresponds to pixel coordinate value P(1, 1), the second input pixel coordinate value corresponds to pixel coordinate value P(2, 2), and the selected color value is I_1, the corresponding input-output-pair is the input-output-pair B_M×X+2.

In accordance with one embodiment of the present invention, in the step S4, when the display component 110 receives some of the sub-pixel coordinate values and some of the color component values corresponding to the corresponding input-output-pair, some of the sub-pixels having the some of the sub-pixel coordinate values corresponding to the corresponding input-output-pair separately display a plurality of sub-pixel colors according to the some of the color component values corresponding to the corresponding input-output-pair. For example, when the some of the sub-pixel coordinate values corresponding to the corresponding input-output-pair are sub-pixel coordinate values S(1, 1)-S(2, 2), and the some of the color component values corresponding to the corresponding input-output-pair are color component values R_2, G_2, B_2, W_2, the sub-pixel P_11a displays one of the sub-pixel colors (e.g., red color) according to the color component value R_2, the sub-pixel P_11b displays one of the sub-pixel colors (e.g., green color) according to the color component value G_2, the sub-pixel P_11c displays one of the sub-pixel colors (e.g., blue color) according to the color component value B_2, and the sub-pixel P_11d displays one of the sub-pixel colors (e.g., white color) according to the color component value W_2.

It should be noted that, in the embodiments above mentioned, although the user command includes only one or two input pixel coordinate value(s), but in practical, the user command can include three or more input pixel coordinate values (e.g., the user command corresponding to a function for drawing a curve) and is not limited by the user command in the embodiments above mentioned

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display device, comprising:
a display component comprising a plurality of pixels, wherein each of the pixels has a pixel coordinate value, each of the pixels comprises a plurality of sub-pixels, each of the sub-pixels of the pixels has a sub-pixel coordinate value;
a storage component configured to store a plurality of index tables, wherein each of the index tables comprises a plurality of input-output-pairs, each of the input-output-pairs corresponds to some of the sub-pixel coordinate values and a plurality of color component values; and
a processing component configured to receive and according to a user command to search a corresponding index table from the index tables, to search a corresponding input-output-pair from the input-output-pairs in the corresponding index table, and to provide some of the sub-pixel coordinate values and some of the color component values corresponding to the corresponding input-output-pair to the display component;
wherein the display component is configured to display an image according to the some of the sub-pixel coordinate values and the some of the color component values corresponding to the corresponding input-output-pair.

2. The display device as claimed in claim 1, wherein some of the sub-pixels having the some of the sub-pixel coordinate values corresponding to the corresponding input-output-pair display a plurality of sub-pixel colors according to the some of the color component values corresponding to the corresponding input-output-pair.

3. The display device as claimed in claim 1, wherein the user command comprises a selected function, at least one input pixel coordinate value, and a selected color value.

4. The display device as claimed in claim 3, wherein the processing component is further configured to search the corresponding index table from the index tables according to the selected function of the user command.

5. The display device as claimed in claim 3, wherein each of the input-output-pairs in the index tables further corresponds to at least one of the pixel coordinate values and an index color value, the processing component is further configured to compare the at least one input pixel coordinate value in the user command with the pixel coordinate values corresponding to the input-output-pairs in the corresponding index table, and compare the selected color value of the user command with the index color values corresponding to the input-output-pairs in the corresponding index table, so as to search the corresponding input-output-pair.

6. The display device as claimed in claim 5, wherein the at least one input pixel coordinate value of the user command comprises a first input pixel coordinate value and a second input pixel coordinate value, the at least one pixel coordinate value of each of the input-output-pairs in the corresponding index table comprises a first pixel coordinate value and a second pixel coordinate value,
the processing component is further configured to compare the first input pixel coordinate value in the user command with the first pixel coordinate values corresponding to the input-output-pairs, compare the second input pixel coordinate value in the user command with the second pixel coordinate values corresponding to the input-output-pairs, and compare the selected color value of the user command with the index color values corresponding to the input-output-pairs in the corresponding index table, so as to search the corresponding input-output-pair.

7. A display method, used in a display device, wherein the display device comprises a display component, a storage component, and a processing component, the display component comprises a plurality of pixels, each of the pixels has a pixel coordinate value, each of the pixels comprises a plurality of sub-pixels, each of the sub-pixels of the pixels has a sub-pixel coordinate value, the storage component is configured to store a plurality of index tables, each of the index tables comprises a plurality of input-output-pairs, each of the input-output-pairs responds to some of the sub-pixel coordinate values and a plurality of color component values, the display method comprises:
receiving and according to a user command to search a corresponding index table from the index tables;
searching a corresponding input-output-pair from the input-output-pairs in the corresponding index table according to the user command;
providing some of the sub-pixel coordinate values and some of the color component values corresponding to the corresponding input-output-pair to the display component; and
displaying an image according to the some of the sub-pixel coordinate values and the some of the color component values corresponding to the corresponding input-output-pair.

8. The display method as claimed in claim 7, wherein the step of receiving and according to the user command to search the corresponding index table from the index tables comprises:
making some of the sub-pixels having the some of the sub-pixel coordinate values corresponding to the corresponding input-output-pair display a plurality of sub-pixel colors according to the some of the color component values corresponding to the corresponding input-output-pair.

9. The display method as claimed in claim 7, wherein the user command comprises a selected function, at least one input pixel coordinate value, and a selected color value, the step of searching the corresponding input-output-pair from the input-output-pairs in the corresponding index table comprises:
searching the corresponding index table from the index tables according to the selected function of the user command.

10. The display method as claimed in claim 9, wherein each of the input-output-pairs in the index tables further corresponds to at least one of the pixel coordinate values and an index color value, the step of searching the corresponding input-output-pair from the input-output-pairs in the corresponding index table according to the user command comprises:
comparing the at least one input pixel coordinate value in the user command with the pixel coordinate values corresponding to the input-output-pairs in the corresponding index table; and
comparing the at least one input pixel coordinate value in the user command with the pixel coordinate values corresponding to the input-output-pairs in the corresponding index table.

11. The display method as claimed in claim 10, wherein the at least one input pixel coordinate value of the user command comprises a first input pixel coordinate value and a second input pixel coordinate value, the at least one pixel coordinate value of each of the input-output-pairs in the corresponding index table comprises a first pixel coordinate value and a second pixel coordinate value, the step of searching the corresponding input-output-pair from the input-output-pairs in the corresponding index table according to the user command comprises:
comparing the first input pixel coordinate value in the user command with the first pixel coordinate values corresponding to the input-output-pairs;
comparing the second input pixel coordinate value in the user command with the second pixel coordinate values corresponding to the input-output-pairs; and
comparing the selected color value of the user command with the index color values corresponding to the input-output-pairs in the corresponding index table.
